(19) United States
(12) Patent Application Publication
(10) Pub. No.: US 2016/0134495 A1
(43) Pub. Date: May 12, 2016

(54) LOGGING DEVICE AND LOG AGGREGATION DEVICE

(71) Applicant: KONINKLIJKE PHILIPS N.V., Eindhoven (NL)

(72) Inventors: SEBASTIAN EMILIAN BANESCU, EINDHOVEN (NL); MILAN PETKOVIC, EINDHOVEN (NL); MINA DENG, SHANGHAI (CN)

(21) Appl. No.: 14/898,856

(22) PCT Filed: Jun. 20, 2014
(86) PCT No.: PCT/IB2014/062461

§ 371 Date: Dec. 16, 2015

(30) Foreign Application Priority Data
Jun. 28, 2013 (EP) 13174248.8

(51) Int. Cl. H04L 12/26

(52) U.S. Cl. CPC H04L 43/06; H04L 43/04

(57) ABSTRACT

A logging device (110) and a log aggregation device are provided. The logging device is configured to collaborate with at least one other logging device (120, 130), the logging device and the at least one other logging device together forming a set of logging devices configured to communicate among each other over a communications network, the logging device being configured to collaboratively execute a process together with the at least one other logging device, a process defining related activities to be executed at a logging device of the set of logging devices, an activity of a process being initiating or dependent, a dependent activity being dependent upon at least one previous activity of the same process, the logging device comprises a log manager (112) and a log buffer (114), the log manager is configured to produce for an activity executed on the logging device an associated log entry and to write the log entry to the log buffer, said log entry comprises a data entry and a chaining value, the data entry comprises information on the activity to which the log entry is associated, the log manager is configured to compute the chaining value for a log entry associated with an activity so that: if the activity is an initiating activity, the chaining value is set to an initiating chaining value, and if the activity is a dependent activity, the chaining value is computed from all log entries associated with the activities on which the dependent activity depends.

### FIELD OF THE INVENTION

The invention relates to a logging device, configured to produce for an activity executed on the logging device an associated log entry and to write the log entry to a log buffer.

### BACKGROUND

In information systems, logging mechanisms are used to record occurring events into an audit log. Each event causes the creation of a new log entry in the audit log. A log entry may describe the event which causes its creation by means of a tuple of attributes, such as the subject that triggered the event, the objects involved in the event, when the event occurred, etc.

At the operational level, an organization defines one or more processes, including business processes. A process is a structured collection of activities. Every event occurring in an information system represents the execution of an activity from the process. One of the purposes of recorded logs is to aid the reconstruction of event chains during operational or compliance audit of information systems.

Some of processes are required by law to have a logging system. Many of the rules related to such logging systems refer to the order in which activities must be executed. However, known logging schemes only protect the log, e.g., the integrity and confidentiality thereof, when the log is in transmission over a network and/or while data is at rest in a log storage. These logging-systems do not address the problem of aggregating logs from different devices that collaborate during the execution of the same process.

RFC 3164, by Lonvick, C, titled “The BSD syslog Protocol. Request for Comments: 3164” illustrates a logging system. The logging system includes the following entities: devices, relays and collectors. In that system: A machine that can generate a log entry is referred to as a “device”. A machine that can receive the log entry and forward it to another machine is referred to as a “relay”. A machine that receives the log entry and does not relay it to any other machines is referred to as a “collector”.

### SUMMARY OF THE INVENTION

It would be advantageous to have an improved logging device configured to collaborate with at least one other logging device. It would be of particular advantage to have a log mechanism that protects the integrity of the ordering of logs.

The logging device and the at least one other logging device together form a set of logging devices configured to communicate among each other over a communications network. The logging device comprises a log manager and a log buffer.

The log manager is configured to produce for an activity executed on the logging device an associated log entry and to write the log entry to the log buffer, said log entry comprises a data entry and a chaining value, the data entry comprises information on the activity to which the log entry is associated the activity is initiating or dependent, a dependent activity being dependent upon at least one previous activity.

The log manager is configured to obtain dependency information for the activity, the dependency information indicating whether the activity is initiating or dependent. In case the activity is dependent, the dependency information also indicates log entries associated with the activities on which the dependent activity depends.

The log manager is configured to compute the chaining value for a log entry associated with an activity so that:

if the activity is an initiating activity, the chaining value is set to an initiating chaining value, and

if the activity is a dependent activity, the chaining value is computed from log entries associated with the activities on which the dependent activity depends.

A crucial issue of auditing distributed environments such as cloud environments is aggregating audit logs that originated from different devices or collectors. The aggregation is important as it is necessary to log a process. A set of log entries are called correlated if they describe events generated by activities of the same process. It would be of advantage to have a log mechanism that protects the integrity ordering of logs.

Through the chaining value it is possible to reconstruct the sequence of events in a process. Not only are the events corresponding to a process extracted, but also the order in which activities (events) occurred.

Existing logging schemes do not provide a solution for the case extraction problem, i.e. obtaining the log entries for related activities in the correct order, when logging is distributed over multiple devices.

Time stamps are considered at best to be only a partial solution, since it requires strong clock synchronization: the timestamps need to be consistent between several nodes and devices generating log entries; and relies on a central timestamp sever for clock synchronization, which implies communication overhead.

An activity executed on the logging device may include generating, processing, archiving an electronic message, possibly in depended of previous activities that took place before the current activity. An activity may comprise an activity performed by hardware comprised in or connected to the logging device, e.g., a sensor reading. An activity may comprise receiving input from a user. The set of logging device may collaborate together so that multiple activities together contribute to some result, e.g., an electronic file or electronic document or electronic message.

The log manager is configured to obtain dependency information for the activity. The logging manager may also receive the dependency information from an execution unit of the logging device configured for executing the activity. The dependency information may be received from a source outside the logging device, e.g., from a user. The logging unit may obtain the dependency information from a process defining the related activities, which may process may be stored on the logging device.

In case the activity is dependent, the dependency information also indicates log entries associated with the activities on which the dependent activity depends, and preferably all such log entries.

For those activities on which the dependent activity depends that executed on the logging device itself, the associated log entries may be obtained from the log buffer. For those activities on which the dependent activity depends that executed on a logging device of the at least one other logging device the associated log entries may be obtained from that logging device or from a collector that stores the logging entries for that device.

In an embodiment, the logging device is configured to collaboratively execute a process together with the at least one other logging device. A process defines related activities to be executed at a logging device of the set of logging devices. An activity of a process is initiating or dependent. A dependent activity is dependent upon at least one previous activity of the same process.

There may be other activities executing on a device which do not produce a log entry, but such activities are not considered as separate activities of a process. The logging device may be used in distributed settings/systems where secure log services are needed as well as extraction of case logs.

In an embodiment, computing the chaining value comprises computing a hash function over the log entries associated with the activities on which the dependent activity depends. For example, computing a hash function over the concatenation of all log entries associated with the activities on which the dependent activity depends.

In an embodiment, the log entry comprises a signature over at least the data entry and the chaining value.

In an embodiment, the data entry is encrypted with a first symmetric key. The log entry comprises the first symmetric key encrypted with a second key. The first symmetric key is unique for the log entry, e.g., chosen at random. The second key depends on the type of information in the log entry. For example, the type may be sensitive or non-sensitive. By disclosing the second key for a particular type, data entries of that type may be decrypted. The second key may be symmetric or asymmetric. In case of an asymmetric second key a decryption key for the second key is disclosed.

In an embodiment, the logging devices senses events using a sensor and creates corresponding log entries. At pre-established time intervals, the devices send messages containing log entry files (also known as log entry bundles), over the network, to relays or directly to collectors. Relays only serve as message forwarders. Collectors receive messages containing log entries, may verify their authenticity and integrity, and store entries in the audit log.

In an embodiment, the logging device is configured to execute an initiating activity. For example, the process may define an initiating activity for execution on the logging device.

In an embodiment, the logging device is configured to execute a dependent first activity depending on a second activity, wherein the second activity is executed on a device of the at least one other logging device.

In an embodiment, the logging device is configured to execute a dependent activity, depending on at least two previous activities executed on a logging device of the set of logging devices. For example, the processes may define a dependent activity, depending on at least two previous activities for executing on the logging device.

An aspect of the invention concerns a log aggregation device comprising an aggregator and a threading unit. The aggregator is configured to collecting log entries from log devices to obtain an aggregated log. The threading unit is configured to search in the aggregated log for one or more log entries so that a chaining value computed from the searched one or more log entries equals a target chaining value of a target log entry, and if the one or more log entries are found, labeling the target log entry as a dependent activity. The aggravation device makes use of the chaining value to determine which log entries were used when performing an activity. The order of the activities is preserved in the log.

The logging device and log aggregation device are electronic devices; they may be mobile electronic devices such as a mobile phone, or a tablet.

An aspect of the invention concerns a logging method for a device collaborating with at least one other logging device, and a method for log aggregation.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code means stored on a computer readable medium for performing a method according to the invention when said program product is executed on a computer

In a preferred embodiment, the computer program comprises computer program code means adapted to perform all the steps of a method according to the invention when the computer program is run on a computer. Preferably, the computer program is embodied on a computer readable medium.

### BRIEF DESCRIPTION OF THE DRAWINGS

These and other aspects of the invention are apparent from and will be elucidated with reference to the embodiments described hereinafter. In the drawings,

FIG. 1 is block diagram illustrating a logging system,

FIG. 2a, 2b, 2c are process flow diagrams illustrating collaboratively executed processes,

FIG. 3a, 3b, 3c are block diagrams illustrating labeled aggregated logs,

FIGS. 4a and 4b are an illustration of a display produced by a display controller,

FIG. 5 is block diagram illustrating a logging system,

FIG. 6 is a flow chart illustrating a logging method for a device collaborating with at least one other logging device,

FIG. 7 is a flow chart illustrating a method for log aggregation.

It should be noted that items which have the same reference numbers in different Figures, have the same structural features and the same functions, or are the same signals. Where the function and/or structure of such an item has been explained, there is no necessity for repeated explanation thereof in the detailed description.

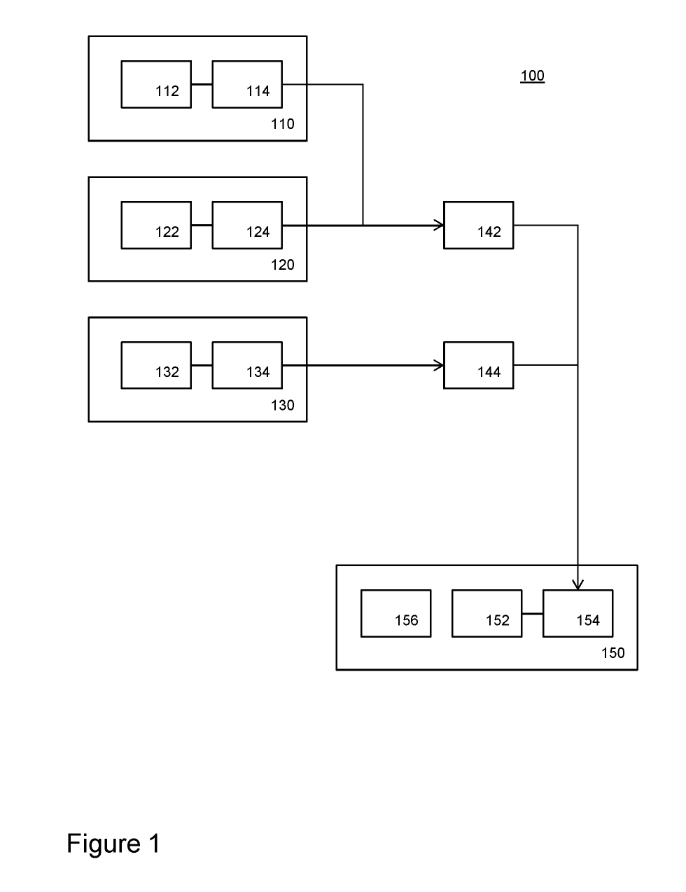

### LIST OF REFERENCE NUMERALS IN FIG. 1

100 a logging system
110, 120, 130 a logging device
112, 122, 132 a log manager
114, 124, 134 a log buffer
142, 144 a log collector
150 a log aggregation device
152 a threading unit
154 an aggregator
156 a display controller

### DETAILED DESCRIPTION OF EMBODIMENTS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

FIG. 1 is block diagram illustrating a logging system 100.

Logging system 100 comprises a set of logging devices. Shown are logging devices 110, 120, and 130. Logging devices are also referred to as nodes. The set of logging devices comprises at least two logging devices. For example, the set may comprise 2 or more logging devices, 3 or more, and so on. Logging system 100 comprises optional log collectors 142 and 144, and a log aggregation device 150.

The set of logging devices are configured to communicate among each other over a communications network, say a local area network or the Internet, e.g., by exchanging messages. A logging device comprises a log manager and a log buffer. For shown devices, logging device 110 comprises log manager 112 and log buffer 114; logging device 120 comprises log manager 122 and log buffer 124; and logging device 130 comprises log manager 132 and log buffer 134. A logging device is also referred to as a logger.

The logging devices are configured to execute a process together. Parts of the process are executed at one of the set of logging devices, another part at another device.

A process defines a series of activities to be executed at a logging device of the set of logging devices. For example, the process may be a data processing process, in which data is required and produced in an activity. A process may also define a sequence of messages that are required to be exchanged between the logging devices. A process may define a series of actions to be executed at devices of the set of devices, e.g., to achieve a result, at least some of the actions in a process requiring a previous execution of an action of the same process.

A process does not need to be a linear series; a process may include forks and joins. In a fork two different logging devices execute an activity depending on a same earlier activity. In a join, a logging device executes an activity depending on two earlier activities, in particular two earlier activities executed on different logging devices.

The logging devices may be used to log the activities in some technical process, e.g., a manufacturing process. However, the logging devices are also suitable for logging a business process. The logging system addresses the technical problem of securing the ordering in a log that was produced at multiple devices. An instance of a process is referred to as a case, or simply as the process.

The process may be defined, in a business process modeling language, or it may be defined in software. Preferably, an activity of the process defines the required activities (if any) that must have occurred before any given activity. An activity of a process may be initiating or dependent. An initiating activity does not require execution of a previous activity. A dependent activity is dependent upon at least one previous activity of the same process. The dependence may be enforced by a software application running in or associated with the logging device. This is not strictly necessary; it may also be the case that a user of the logging device decides that he performs a step in the process based on certain data available to him. The data used by the user may also be recorded as a dependency. For example a logging device may be configured to identify the information presented to the user, say as currently on the screen, or as presented in a past time interval, determine corresponding log entries of activities from which the information originated, and assigning the current activity as dependent upon said determined activities. In this way, it may later be determined on what basis a user made a decision.

The logging devices may be configured for a number of processes. Different processes may have different dependencies. For example, a user of a logging device may input which process to execute.

The log managers 112, 122, and 132 are configured to produce for an activity executed on the logging device an associated log entry and to write the log entry to the log buffer 114, 124, 134 respectively. Below we will further describe logging device 110, but this description also applies to logging devices 120 and 130. The logging devices in the set of logging devices may be identical devices but this is not needed. On the contrary, the system may well be used by different cooperating devices, each producing a log.

A log entry has a format comprising different parts.

A log entry comprises at least a data entry and a chaining value. The data entry comprises information on the activity to which the log entry is associated. This part depends on the particular process that is being logged. The data entry may be sensor data of a sensor of the logging device. The data may be text, voice data, image data and the like. For example, a data entry describes the event which causes the creation of the log entry, e.g., by means of a tuple of attributes, such as the subject that triggered the event, the objects involved in the event, when the event occurred, etc.

When the logging device executes an activity of a process, say on a processor running corresponding software, a signal is generated and sent to the logging manager. For example, the processor could generate and send this signal. The signal may include the type of the activity, i.e., independent or dependent. If the activity is independent the process associated with the activity may be identified, e.g., by identifier. If the activity is dependent the signal may include what the activity depends on.

The log manager is configured to determine whether the activity that is dependent or independent e.g., from a signal received from another part, say the processor. The log manager may also determine this without such a signal, e.g., by inspecting a process description.

The log manager is configured to determine the chaining value for a log entry associated with an activity, so that:

if the activity is an initiating activity, the chaining value is set to an initiating chaining value, and

if the activity is a dependent activity, the chaining value is computed from all log entries associated with the activities on which the dependent activity depends.

For example, the initiating value may depend on which process of the number of number of processes is executed. For example, each process of the number of processes may have a unique process identifier, the initiating chaining value depending on the process identifier of the process defining the activity associated with the log entry.

For example, the chaining value may be a process identifier concatenated with a unique execution identifier. The unique execution identifier may be a serial number, e.g., indicating how many times this particular process has been initiated. The unique execution identifier may be a random number obtained from a random number generator. The latter has the advantage of reducing the probability of collision without overhead to distribute serial numbers among the set of devices.

The chaining value may be computed in a number of ways. The logging algorithm is configured with a chaining value algorithm, e.g., in software or dedicated hardware that performs the computation. It is preferable, if the chaining value algorithm comprises a cryptographic hash function so that it is highly unlikely that two different inputs to the chaining value algorithm produce the same chaining value.

For example, the chaining value algorithm may concatenate all log entries associated with the activities on which the dependent activity depend, and hash the result. For example, the chaining value algorithm may hash all log entries associated with the activities on which the dependent activity depends, then concatenate the hashes, preferably the concatenated hash is itself hashed. The latter step ensures that chaining values have the same length.

Many hash functions exist, a possible choice is SHA-256. The bit size of the hash is a security trade off. A longer bit size is more secure but consumes more resources. If the chosen hash function is too long, the result may be truncated, say to 128 bit.

Conventional logging systems, which use references to previous event or use next event identifiers (IDs), may have problems in a distributed cloud-environment because audit logs stored in different independent storage facilities may have the same IDs. Hash functions that provide collision resistance are more appropriate for this purpose since they may uniquely identify log entries across several systems and even across different clouds.

The format of the i^{th} log entry may have multiple fields. A first field is the payload of the log entry denoted by dataᵢ. The second field is the hash of a specific log entry eⱼ located on some log buffer or on one of the log collectors denoted by C_{y}. Note that eᵢ may be located on a same C_{y}, or on a different one. A second field is the chaining value, also referred to as the “case hash” (CH) value, and will be denoted by hᵢ. The hᵢ preserves the order of any set of correlated log entries across several collectors. This information may be computed at application level where the execution of the process leads to a sequence of activities that generate log entries. For example, an activity aⱼ (that generates eⱼ) may immediately precede activity aᵢ (that generates eᵢ) during the execution instance of the process. It is not needed that activity aⱼ immediately precede activity aᵢ. For example eᵢ=dataᵢ∥H(eⱼ@C_{y}), in case the log entry depends on a single other log entry. “@C_{y}” indicates that the log entry on which the new log entry depends could be physically located at another location. Information indicating where a log entry was stored may b included in the chaining value but this is not needed.

The nodes (devices) may comprise a chaining value module (not separately shown) that provides ordering information for events belonging to the same process. The chaining value module communicates this information to the log manager on the corresponding node (device). The chaining value module may also compute the chaining value itself. The ordering information may be included in the log entry. This significantly reduces searching during aggregation in case of multiple dependencies. This ordering information may be used by an aggregator entity to create an audit profile against a specific process execution spanning across several nodes and devices.

Optionally, logging device 110 may comprise a random number generator. Logging device 110 is configured to call the random number generator and include a generated number generator in a produced log entry. This protects against a logging device generating fake dependent log entries. Sometimes a process is predictable; a logging device may be able to predict how the logging entry of anther device will contain. If so, the logging device may include the predicted log entry in the computation of a chaining value. This makes it look as if the logging device has access to a log entry, even though it did not. By including a random number, the possibility of fraud by another device is reduced. The random number generator may be true random or pseudo random. At the least, the outputs of the random number generator are unpredictable for the other devices in the set, and preferably, also for log aggregation device 150.

Log aggregation device 150 comprises an aggregator 154 and a threading unit 152.

Aggregator 154 is configured for collecting the log entries from the log devices in the set, e.g., 110, 120 and 130, to obtain an aggregated log. For example, aggregator 154 comprises an aggregated log buffer to store the aggregated log. Aggregator 154 may aggregate the logs by concatenation. In a more advanced implementation, aggregator 154 may build a database in which the obtained log entries are records.

Aggregator 154 may communicate with the logging devices over the communication network, but aggregator 154 may also receive the log out-of-band; say over a USB stick. The log entries obtained by aggregator 154 are as described herein.

Logging system 100 may optionally comprise one or more log collectors. FIG. 1 shows two log collectors: log collector 142 and log collector 144. A log collector collects log entries from a logging device and stores it. Later if the log may be transmitted to log aggregation device 150. In FIG. 1, log collector 142 collect log entries from logging device 110 and logging device 120. Log collector 144 collect log entries from logging device 130.

Using the chaining values in the log entries, log aggregation device 150 may reconstruct the order in which the activities took place. For example, threading unit 152 may be provided with a target log entry, typically from the aggregated log. From target log entry a target chaining value is obtained. Threading unit 152 may be used to find out on what the target activity is dependent.

Threading unit 152 is configured to

search in the aggregated log for one or more log entries so that a chaining value computed from the searched one or more log entries equals a target chaining value of a target log entry of the aggregated log, and

if the one or more log entries are found, labeling the target log entry as a dependent activity.

Furthermore, if the one or more log entries are found the target log entry may be labeled with backward pointers to the found log entries. In this way, one may look-up from a log entry on which log entries it depends. Vice versa, the found log entries may be labeled with forward pointers, pointing to the target log entry. In this way, one may look-up from a log entry which log entries depend on it. Such labeling with back- or forward pointers is conveniently done if the aggregate log is in a database, but other data structures will also work, say a linked list may be employed for the pointers.

The threading unit may be configured to determine if the chaining value is an initiating chaining value, and if so, labeling the log entry as an initiating activity. If the chaining value algorithm is sufficiently secure, i.e., secure against second pre-image, identifying a chaining value as initiating rules out the possibility of finding log entries that together give the chaining value in the chaining value algorithm. The threading unit may be configured to determine if the chaining value is an initiating chaining value, and if so, skip the searching. However, if the chaining value algorithm is weak or untrusted, the search may be done as well.

Finding a log entry as both independent and dependent is considered an error, an alert may be generated by the aggregation device, e.g., through a display controller. Finding a log entry that is neither initiating nor dependent is also undesired, but need not necessarily be an error; A warning may be generated by the aggregation device, e.g., through a display controller.

In an embodiment, the threading unit is configured to apply threading unit 152 to each log entry in the aggregated log as a target log entry. In this way the entire aggregated log will be labeled, preferably with both forward and backward pointers.

Once the aggregated log has been labeled various checks may be performed on it. For example, the threading unit may be configured to verify that the log entries in the aggregated log from a directed acyclic graph. Either the forward or backward pointers are taken as the edges of the graph and the log entries as the vertices (also referred to as nodes). Since backward pointers are slightly easier to obtain than forward pointers, the check may be done on the backward pointers. Determining if a graph is directed acyclic graph may be done by performing a depth-first-search on each vertex. If the depth-first-search finds the starting vertex that the graph is cyclic.

The following algorithm may be used:

```
def isDAG(nodes V):
        while there is an unvisited node v in V:
              bool cycleFound = dfs(v)
              if cycleFound:
                      return false
        return true
```

Finding that the aggregated log is cyclic is an error, an alert may be generated, e.g., through a display controller.

Preferably, when some entity wishes to extract the cases from various log files located on different storage entities such as collectors, log aggregation device 150 may first verify the integrity of each individual log obtained from a device or collector and/or verify the integrity of each individual log entry. Afterwards, all log entries, or log files may be appended and put into an aggregated log, referred to as λ.

The log aggregation device is particularly useful for audits. For example, log aggregation device 150 may comprise a display controller 156. A display may be connected to the display controller.

Display controller 156 is configured to display a representation of the target log entry of the aggregated log, display a representation of the backward pointers to log entries in the aggregated log on which the target log entry depends. In addition, display controller 156 may display a representation of log entries in the log entry on which the target log entry depends.

A pointer may be represented by a line or arrow. A log entry may be represented visually by dot, or a labeled dot. The log entry may also be represented by the data entry, or a summary or portion thereof. A log entry representation may include a representation of the device which generated the log entry.

Typically, device 100 and the 150 each comprise a microprocessor (not shown) which executes appropriate software stored at the device 100 and the 150; for example, that software may have been downloaded and stored in a corresponding memory, e.g., a volatile memory such as RAM or a non-volatile memory such as Flash (not shown).

During operation logging system 100 may work as follows: For example two users need to collaborate in order to execute a process. The process may be a business process as described in business process notation, say Unified Modeling Language or Business Process Modeling Notation. Each user may be located at different physical locations. Say one user uses logging device 110, the other logging device 120.

In a distributed cloud environment it is often the case that several users need to collaborate for the successful execution of a business process. Several Collector entities may exist due to various reasons, for example an organization may set up a dedicated collector for each physical location they run operations in. Depending on the organization these physical locations may span over different cities, countries or even continents.

Each activity is executed by a user generating an event on the corresponding node (device), which is subsequently recorded in the log buffer of that node (device). The contents of different node (device) log buffers may be sent to different collectors/storage. The logs may be protected in transit and at rest from unauthorized log data access and modification by other means.

Once logs are collected from multiple logging devices, searches may be done on them. For example, an auditor may want to review the logs, or a technician depending on the nature of the logged process. In both cases, the order of the logs may be reproduced through the chaining values.

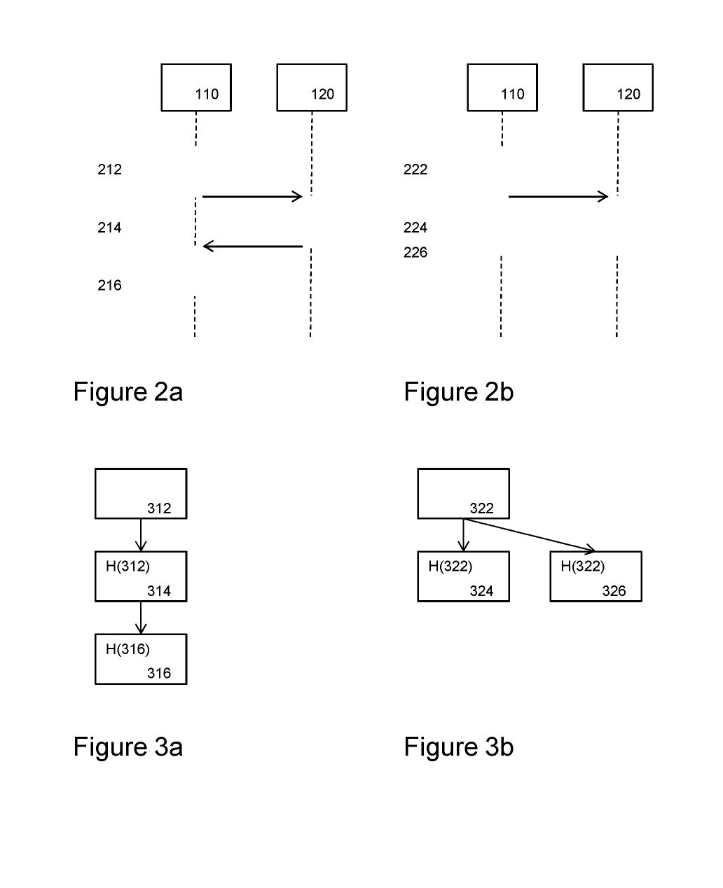

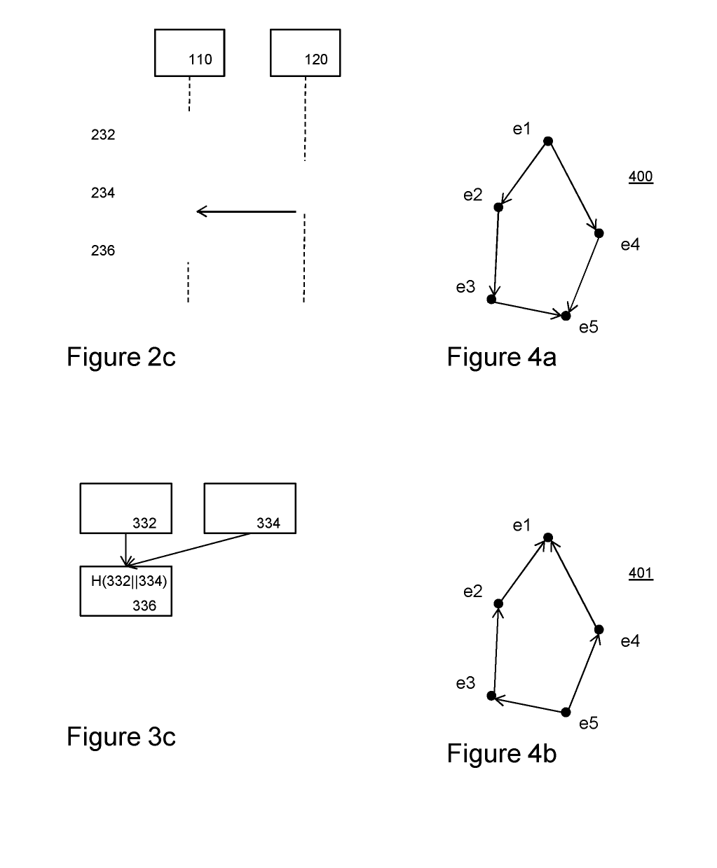

FIGS. 2a, 2b and 2c show various ways in which devices may collaborate. FIGS. 3a, 3b and 3c show part of the directed acyclic graph that may be displayed by display controller 156 and that corresponds to FIGS. 2a, 2b and 2c respectively. FIGS. 2a, 2b and 2c are process diagrams. Time flows from top to bottom. A bar drawn over the dotted line indicates that the corresponding device is executing an activity. References numbers 212-236 indicate moments in time. Arrows in FIGS. 2a-2c indicate dependent activities as forward pointers. All activities belong to the same process. The hand-off of a process, e.g. as indicated with an arrow in FIGS. 2a-2c may comprise sending an electronic message from one logging device to the other, in the direction of the arrow. The message may comprise information indicating the process and the activity to be performed on the other device(s).

For clarity, FIGS. 3a-3c also show a possible computation of the chaining value. H( ) refers to a hash function. The hash is preferably taken of the entire log entry indicated. ∥ indicates concatenation. Instead of concatenation other combining functions may be used. The chaining value would not typically be displayed.

FIG. 2a shows that logging device 110 is executing an activity at moment 212. A log entry 312 is generated. The process continues at logging device 120. At moment 214 logging device 120 is executing an activity and generates log entry 314. At moment 216 logging device 110 is executing an activity and generates log entry 316. The log entry 314 has a chaining value that depends on log entry 312, e.g. it is the hash over log entry 314. FIG. 3a indicates the dependencies between the three log entries, with forward pointers. This type of collaborative computation referred to as ‘sequential’.

FIG. 2b shows that logging device 110 is executing an activity at moment 222, a log entry 322 is generated. The process continues at device logging device 120, but also continues at logging device 110. This type of collaboration is termed a ‘fork’. At moments 224 and 226 both logging device 110 and logging device 120 are executing an activity of the log. Both devices generate a log entry. In this case logging device 110 is somewhat earlier, and generates log 324 and logging device 120 generated log entry 326. FIG. 3b indicates the dependencies between the three log entries, with forward pointers.

FIG. 2c shows that logging device 110 is executing an activity at moment 232, a log entry 332 is generated. The process continues at device logging device 110. At moment 234 an activity is executed at logging device 120, a log entry 334 is generated. At moment 236 an activity is executed at logging device 110 that depends both on the activity executing a 232 and on the activity executing at moment 234 at logging device 120. This type of collaboration is termed a ‘join’. At moment 236 logging device 110 is executing an activity and generates log entry 336. FIG. 3c indicates the dependencies between the three log entries, with forward pointers.

FIG. 4a shows a display of a directed acyclic graph 400. Shown are representations of log entries. In this case 5 log entries are shown. In this case, the log entries are labeled with identifiers. Here identifiers e1, e2, e3, e4 and e5 are used. For example, display controller 156 may be configured so that a user may select a represented log entry. In response, the content or part thereof of the represented log entry may be displayed.

FIG. 4b shows the same log, but with backward pointers.

The system preserves the order and integrity of audit logs of processes performed in a distributed (cloud-based) system. There is no need to store audit logs on a centralized server. Although time stamps may be included in a log entry, time stamps are not necessary to correlate the logs collected from different storage servers to one another. No central time stamping server is needed. Log entries are correlating events using hash chains. Below additional information is provided on possible embodiments and variants. Also additional information on underlying technology is provided.

A hash function, denoted H, is a computationally efficient algorithm that maps any binary value from a variable length domain to a k-bit value from a fixed length domain, i.e. H: {0,1}̂*→ [symbol] {0,1} [symbol] ̂k. A cryptographic hash function is a hash function having three important properties: Pre-image resistance (one-way-ness)-H is pre-image resistant if given yε [symbol] {0,1} [symbol] ̂k it is computationally unfeasible to compute xε [symbol] {0,1} [symbol] ̂* such that H(x)=y. Second pre-image resistance (weak collision resistance)-H is second pre-image resistant if given x_aε [symbol] {0,1} [symbol] ̂* it is computationally unfeasible to find x_2ε [symbol] {0,1} [symbol] ̂* such that H(x_1)=H(x_2). Strong collision resistance-H is strong collision resistant if it is computationally unfeasible to find two values x_1,x_2ε [symbol] {0,1} [symbol] ̂* such that H(x_1)=H(x_2).

In logging system 100 the property of second pre-image resistance is especially important. There should not be two different collections of log entries for which the chaining value algorithm would give the same chaining value.

Typical cloud solutions cause scattered log files for various reasons. For example, in order to tolerate, so-called, Byzantine failures a complex system may be deployed in a Cloud-of-Clouds (CoC) environment, i.e. several independent cloud providers offering on-demand resources for increased resilience capabilities of the same complex system. In case the execution of a process starts in one cloud that goes offline at one point, the execution will replicated and continue on a different cloud. Therefore, correlated log entries will be scattered across audit logs of different cloud providers.

To extract from an aggregated log λ all the cases representing different process executions the following algorithm may be executed. First a target log entry (eₓ) is selected, and the chaining value (hᵣ) is obtained. The chaining value of a directly dependent log entry is obtained, say by computing H(eₓ) and a search is made for log entries that have this chaining value; if any such entries are found then create a node for each log entry and set them as the children of the nodes corresponding to the log entries used to compute the current chaining value. This step is repeated until no more dependent log entries are found. The linear case, in which a string of log entries are sequentially dependent, say as in FIG. 2a, is an important situation, by handling it first, the algorithm is more efficient. Then the chaining value of any combinations of leaf nodes are computed. If a match is found between the chaining value of the combination and a target chaining value the target entry is marked as dependent. If all combinations of leaf nodes have been tried the algorithm stops.

One further alternative of computing the chaining value is to hash the log entries on which an entry depends and to XOR to hash values. Although this way of computing a chaining value has limited second pre-image resistance, it may be acceptable if the number of log entries is low compared to the number of bits in the output of hash function.

A pseudo-code description of the previous algorithm is presented below, using this alternative chaining value algorithm.

```
INPUT: a set of audit logs: λ = U_{λ}_{ᵢ}_{∈C}_{ᵢ}λᵢ , where Cᵢ is a log storage entity
OUTPUT: audit profile:
        {(V,A)|V contains events and A gives a partial order on elements
        of V}
WHILE (∃ e₁ ∈ [symbol]  | e₁[3] = h₁ is case hash of e₁ and h₁ = (p_{ID}|0000)) DO
                  V ← V ∪ {e₁}
                  L ← {e₁}
                  h ← H(e₁)
                  P(h) ← {e₁}
INNER_LOOP:
WHILE (∃e_{c} ∈ λ such that e_{c}[3] = h) DO
                  L ← L \ P(h)
FOREACH e_{c} ∈ λ such that e_{c}[3] = h DO
FORK EXECUTION
IF (process_{current} = process_{child}) THEN
BREAK OUT OF FOREACH LOOP
IF (process_{current} = process_{child}) THEN
                  V ← V ∪ {e_{c}}
FOREACH e ∈ P(h) DO
                  A ← A ∪ {(e, e_{c})}
                  L ← L ∪ {e_{c}}
                  h ← H(e_{c})
                  P(h) ← {e_{c}}
JOIN EXECUTIONS
FOREACH σ ∈ ⊕ (L) DO
IF |σ| > 1 THEN
                  h ← 0
FOREACH e ∈ σ DO
                  h ← h ⊕ H(e)
                  P(h) ← σ
GOTO INNER_LOOP
```

The output of the algorithm is a graph composed out of several connected components, each of which is a Directed Acyclic Graph (DAG). Each DAG corresponds to a different case. The condition of the outer loop is meant to search for a log entry having a distinguished point as its chaining value. If such an entry is found then it is the starting node of a DAG. Note that the set of leafs denoted by L is a shared resource between any threads that are involved in the execution. The next sought chaining value is denoted by h. The set of events whose hashes contributed to the creation of h is denoted by P(h). P(h) is a set and not a single element due to the fact that when two or more branches of the same business process are joined together, the next event has a case hash comprising of the XOR of the hashes of the last event on each branch. The INNER_LOOP represents a label that is used to indicate where the execution should jump to. The purpose of the inner while loop is to search for any log entries that have the chaining value equal to h. Those log entries represent the children nodes of all events in P(h). Several children indicate a fork in the execution of the case. Therefore a separate execution thread is created for each child. At some point the every thread will have reached an event having no direct children. At that point the executions of all threads in the algorithm are joined together to form a single thread. Afterwards this thread is used to search for any combination of leaf nodes whose XOR-ed hashes form a chaining value that is found in any of the remaining log entries in λ. If such an event is found the execution jumps to the INNER_LOOP label. Thereafter, the DAG corresponding to the same case continues to be constructed. The algorithm ends when there are no distinguished points left in λ.

One important thing to note is the fact that due to the introduction of the auxiliary set of leaves L the business process joining points can be computed much more efficiently than without this set. This is due to the fact that the cardinality of the power-set of L is much smaller than that of λ, i.e. | [symbol] (L)|<<| [symbol] (λ)|.

A log manager may be configured for alternative log entry formats. For example, the format may be eᵢ=E(mᵢ)∥H(eᵢ₋₁)∥H(eⱼ@C_{y})∥Vᵢ. The first field is the payload of the log entry mᵢ (also referred to as dataᵢ) encrypted with some key Kᵢ. The second field is the hash of the previous log entry from the same log file. It represents the i^{th} value in the hash chain used to link the entries on the audit log from the same collector. The third field is the chaining value. However, the second field ensures that any reordering or modification of log entries is detected at a single collector level. The chaining value (CH) value is used to preserve the order of any set of correlated log entries across several collectors. The forth field (Vᵢ) is a public key signature on the previous three fields used to ensure the integrity and accountability of each individual log entry. The public key signature may be an RSA signature.

Before aggregating log files from different collectors an auditor should verify the integrity of the separate logs originating from each collector. This way the auditor can detect if any of these individual log files has been tampered with, by verifying the second field and the fourth field. Afterwards all log files are appended to a single file and the case extraction may proceed as described above. Note that one could also use only the fourth field (signature) and rely on the ordering integrity provided by the third field. The second field is then omitted.

In some contexts such as healthcare, log entries contain sensitive or confidential information that must be protected from semi-trusted parties that inspect the log. One approach towards protecting the payload of log entries is through encryption. However, a drawback of logging schemes that protect confidentiality of individual log entries through encryption is that only an entity knowing the secret key (symmetric encryption) or private key (asymmetric encryption) may decrypt and search for log entries. Disclosing the encryption key would provide access to all the recorded log entries.

When a semi-trusted party (e.g. auditor) needs to inspect a subset of entries in the log (e.g. the cases of the business process describing a type of medical treatment of patients) it may be unacceptable to disclose log entries generated by other processes, because they may belong to some other independent party than the party under inspection. However, the auditor must be able to verify the integrity of the logs. Conventionally, log integrity verification may be performed only if all log entries are given to the verifier. After integrity verification, the verifier should be able to decrypt only those log entries that correspond to a particular business process.

An embodiment extends the log ordering with encrypted search. The trusted party that owns the logs has the so called “master secret” used to create any search capability. For instance a capability only allows decryption of a subset of log entries generated by a specific business process, containing a certain keyword, or generated during a certain time period.

A possible flow in the scenario where a semi-trusted party inspects the logs is the following:

A semi-trusted party requests a search capability for a given search criteria (e.g. all log entries generated by the execution of business process p).

The trusted party may decide to give the semi-trusted party the requested search capability.

After the semi-trusted party verifies the integrity of all log files, it uses the search capability to find relevant log entries and then decrypts them.

This embodiment allows semi-trusted parties to decrypt only a subset of log entries. A log entry format for the embodiment is as follows

eᵢ=E_{K}_{ᵢ}(mᵢ)∥H(eⱼ@C_{y})∥{Kᵢ}_{K}_{_{index}}. The first field represents the payload of the log entry (mᵢ) symmetrically encrypted with key Kᵢ. The second field is the chaining value. The third field is the asymmetric encryption of key Kᵢ with a public key K_{index}. The public key is bound to the indexing information of the corresponding entry. Indexing information may be divided into sensitive and non-sensitive information. For instance in the healthcare domain, sensitive information may include patient names and data about medication and illnesses. Non-sensitive information may include timestamps or the business process ID. A search capability K_{index} allows a semi-trusted party to decrypt {Kᵢ}_{K}_{_{index}} only for a fixed subset of log entries and obtain the symmetric key Kᵢ needed to decrypt the payload mᵢ.

An additional log entry format of the i^{th} log entry is as follows

eᵢ=E_{K}_{ᵢ}(mᵢ)∥H(eⱼ@C_{y})∥c_{w}_{ₐ},c_{w}_{_{b}}, . . . ∥(w₁,c₁)(w₂,c₂), . . .

The first field is the payload of the log entry mᵢ encrypted with symmetric key Kᵢ. The second field is the chaining value. The third field consists of two sets related to: sensitive and non-sensitive keywords. The first set contains the ciphertexts {c_{w}_{ₐ}, c_{w}_{_{b}}, . . . } of symmetric key Kᵢ encrypted under the each sensitive keyword associated to that log entry {wₐ, w_{b}, . . . }. For instance, in the healthcare context sensitive keywords could be: patient names, physician names, illnesses, etc. The sensitive set does not indicate the keywords used to encrypt any of the ciphertexts. Therefore the semi-trusted party has to attempt to decrypt each ciphertext.

The second set contains (keyword, ciphertext) pairs: {(w₁,c_{w}_{₁}), (w₂c_{w}_{₂}), . . . } corresponding to each non-sensitive keyword. For example keywords may take the form of timestamps and business process IDs. The non-sensitive set uses the plaintext keywords to indicate exactly which ciphertext can be decrypted using a search capability provided by a trusted party.

In order to avoid partial disclosure of sensitive information, a keyword value from the sensitive set may be formed out of a conjunction of two or more keywords. The number of keyword conjunctions does not have to include all possibilities, i.e. the power-set of keywords. It may include only those conjunctions that may be needed by an auditor of the system. For instance an auditor may be interested in log entries containing a certain illness and a particular medication.

This format is particularly suited to a cloud based environment, where the cloud providers are untrustworthy.

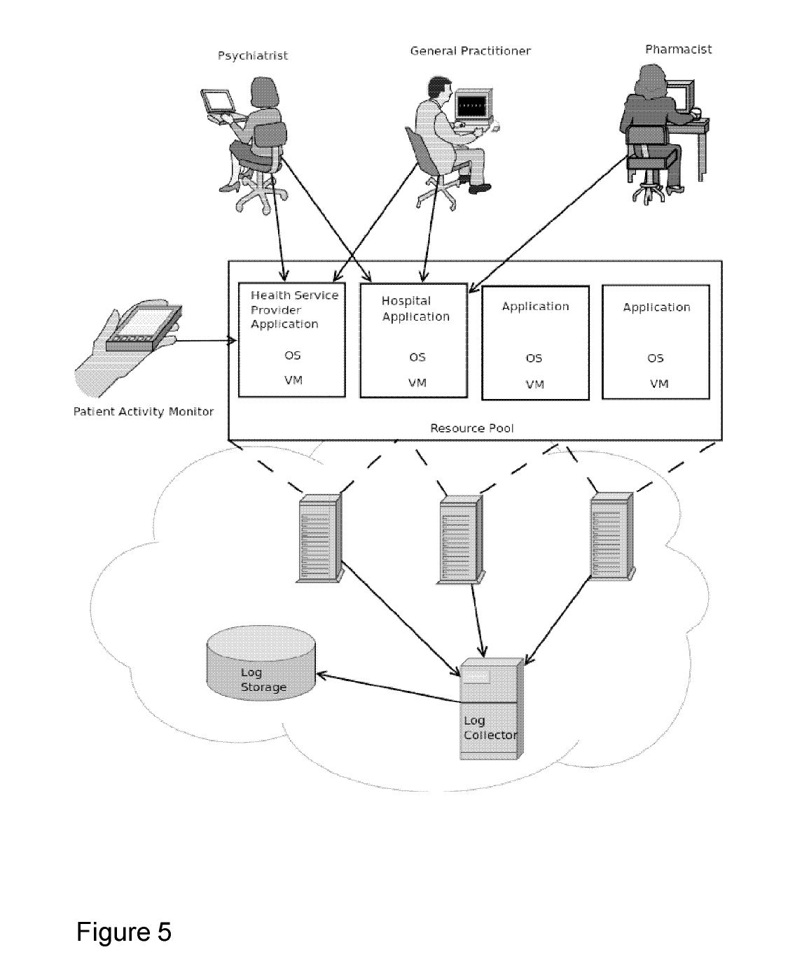

In an embodiment of logging system 100, involves several applications from different vendors offering healthcare solutions. One such embodiment is illustrated in FIG. 5. One vendor known as the Health Service Provider offers monitoring devices for end-users that record their physical activities and sleeping patterns. End-users may upload the measurements recorded by the monitoring devices to a Healthcare Platform offered by the Health Service Provider. Here the end users can view the data themselves or allow professionals such as Psychiatrists or General Practitioners to inspect their data. An end user may also be a registered patient at a hospital providing personalized medical services. The hospital may offer a (different) custom application to end users and professionals. Patients may record any health related events in this application. General Practitioners may prescribe treatments for their patients through the same application and designated Pharmacists may compile a parcel containing all items on a prescription and send it to the right patient. The two applications belonging to the Health Service Provider and the Hospital may collaborate in order to fulfill business processes specified though the collaboration between the two vendors. In such a scenario each application will hold its own audit log. However these logs may need to be aggregated by one or more Log Collectors into dedicated audit log storage.

To improve resilience of a so called Trusted Healthcare Platform the Trusted Healthcare Platform may be instantiated on one of several independent environments from different cloud providers (e.g. Amazon, Microsoft, Google, etc.).

During operation execution of a business process may start while the Trusted Healthcare Platform is running on one cloud. Halfway through the execution of a case, the cloud goes offline because of some technical deficiencies. The Trusted Healthcare Platform is replicated on a different cloud and execution continues from where it was interrupted before. Subsequently this cloud may go offline because of some reasons and the Trusted Healthcare Platform replicated yet again on any other cloud (including the one that went offline in the first place). In such a scenario the audit log may be scattered over several locations belonging to different cloud providers. Aggregation of the audit logs is needed in such a scenario as well.

In an embodiment, a cloud-of-clouds (CoC) is used for the purpose of cloud-based service mash-ups. Here each cloud is privately owned by distinct entities. Each offers certain services to its users. Cloud owners may wish to construct a joint service that involves collaboration and interaction with services offered by different cloud owners. Each cloud providers keeps separate audit logs of its services. However, an auditor may be designated by a higher authority to check compliance of the joint service with legal requirements. In this case audit logs from different cloud providers need to be aggregated.

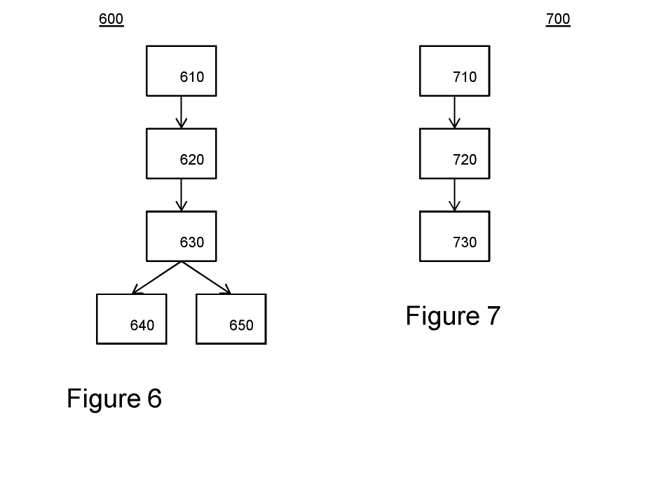

FIG. 6 is a flow chart illustrating a logging method 600 for a device collaborating with at least one other logging device, for example as shown in logging system 100. The illustrated method comprises the following steps. In step 610, a process is collaboratively executed together with the at least one other logging device. In step 620, an associated log entry is produced for an activity executed on the logging device, and the log entry is written to the log buffer. In step 630 the chaining value is computed for a log entry associated with an activity. If the activity is an initiating activity, then in step 640 the chaining value is set to an initiating chaining value, and if the activity is a dependent activity, then in step 650 the chaining value is computed from all log entries associated with the activities on which the dependent activity depends.

FIG. 7 is a flow chart illustrating a method 700 for log aggregation. The method may be executed by log aggregation device 150. The illustrated method comprises the following steps. In step 710 log entries are aggregated from log devices to obtain an aggregated log. In step 720 a search is made in the aggregated log for one or more log entries so that a chaining value computed from the searched one or more log entries equals a target chaining value of a target log entry of the aggregated log. If the one or more log entries are found, then in step 740 the target log entry as is labeled a dependent activity.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method.

A method according to the invention may be executed using software, which comprises instructions for causing a processor system to perform method 600 or 700. Software may only include those steps taken by a particular sub-entity of the system. The software may be stored in a suitable storage medium, such as a hard disk, a floppy, a memory etc. The software may be sent as a signal along a wire, or wireless, or using a data network, e.g., the Internet. The software may be made available for download and/or for remote usage on a server.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A logging device configured to collaborate with at least one other logging device, the logging device and the at least one other logging device together forming a set of logging devices configured to communicate among each other over a communications network,
the logging device comprising a log manager and a log buffer,
the log manager being configured to produce for an activity executed on the logging device an associated log entry and to write the log entry to the log buffer, said log entry comprises a data entry and a chaining value, the data entry comprising information on the activity to which the log entry is associated, the activity being initiating or dependent, a dependent activity being dependent upon at least one previous activity,
the log manager being configured to obtain dependency information for the activity, the dependency information indicating whether the activity is initiating or dependent, and in case the activity is dependent, and log entries associated with the activities on which the dependent activity depends,
the log manager being configured to compute the chaining value for a log entry associated with an activity so that:
if the activity is an initiating activity, the chaining value is set to an initiating chaining value, and
if the activity is a dependent activity, the chaining value is computed from log entries associated with the activities on which the dependent activity depends.

2. A logging device as in claim 1,
the logging device being configured to collaboratively execute a process together with the at least one other logging device, a process defining related activities to be executed at a logging device of the set of logging devices, an activity of a process being initiating or dependent, a dependent activity being dependent upon at least one previous activity of the same process.

3. A logging device as in claim 2, wherein the logging device is configured to collaboratively execute a number of processes together with the at least one other logging device, each process of the number of processes having a unique process identifier, the initiating chaining value depending on the process identifier of the process defining the activity associated with the log entry.

4. A logging device as in claim 1, wherein the log manager comprises a random number generator, and wherein producing the log entry comprises calling the random number generator and including a generated number generator in the log entry.

5. A logging device as in claim 1, wherein
the logging device is configured to execute an initiating activity, and/or
the logging device is configured to execute a dependent first activity depending on a second activity, wherein the second activity is executed on a device of the at least one other logging device, and/or
the logging device is configured to execute a dependent activity, depending on at least two previous activities executed on a logging device of the set of logging devices.

6. A log aggregation device comprising
an aggregator for collecting log entries from logging devices as in claim 1, to obtain an aggregated log, a log entry comprising a chaining value,
a threading unit configured to
search in the aggregated log for one or more log entries so that a chaining value computed from the searched one or more log entries equals a target chaining value of a target log entry of the aggregated log, and
if the one or more log entries are found, labeling the target log entry as a dependent activity.

7. A log aggregation device as in claim 6, wherein labeling the target log entry as a dependent activity comprises labeling the target log entry with one or more pointers to the one or more found log entries.

8. A log aggregation device as in claim 6, wherein the threading unit is configured to determine if the chaining value is an initiating chaining value, by matching at least part of the chaining value with one or more unique process identifiers, and if so, labeling the log entry as an initiating activity.

9. A log aggregation device as in claim 7, wherein the threading unit is configured to verify that a graph formed from the log entries in the aggregated log as vertices and the pointers as edges is a directed acyclic graph.

10. A log aggregation device as in claim 7, comprising a display controller configured to
display a representation of the target log entry of the aggregated log,
display a representation of the pointers to log entries in the aggregated log on which the target log entry depends, and/or
display a representation of log entries in the log entry on which the target log entry depends.

11. A logging system comprising a set of logging devices as in claim 1, and a log aggregation device.

12. A logging method for a device collaborating with at least one other logging device, the logging device and the at least one other logging device together forming a set of logging devices configured to communicate among each other over a communications network, the method comprising
producing for an activity executed on the logging device an associated log entry and writing the log entry to the log buffer, said log entry comprises a data entry and a chaining value, the data entry comprises information on the activity to which the log entry is associated, the activity is initiating or dependent, a dependent activity being dependent upon at least one previous activity,
obtaining dependency information for the activity, the dependency information indicating whether the activity is initiating or dependent, and in case the activity is dependent, log entries associated with the activities on which the dependent activity depends,
computing the chaining value for a log entry associated with an activity so that:
if the activity is an initiating activity, setting the chaining value to an initiating chaining value, and
if the activity is a dependent activity, computing the chaining value from log entries associated with the activities on which the dependent activity depends.

13. A method for log aggregation, the method comprising
collecting log entries from log devices to obtain an aggregated log, a log entry comprising a chaining value,
searching in the aggregated log for one or more log entries so that a chaining value computed from the searched one or more log entries equals a target chaining value of a target log entry of the aggregated log, and
if the one or more log entries are found, labeling the target log entry as a dependent activity.

14. A computer program comprising computer program code means adapted to perform all the steps of claim 12 when the computer program is run on a computer.

15. A computer program as claimed in claim 14 embodied on a computer readable medium.
